(19) United States
(12) Patent Application Publication
(10) Pub. No.: US 2018/0050745 A1
(43) Pub. Date: Feb. 22, 2018

(54) SRAST FAST

(71) Applicant: Alan W. Bewley, Brady, TX (US)

(72) Inventor: Alan W. Bewley, Brady, TX (US)

(21) Appl. No.: 15/629,454

(22) Filed: Jun. 21, 2017

Related U.S. Application Data
(60) Provisional application No. 62/376,424, filed on Aug. 18, 2016.

(51) Int. Cl. B62D 53/06; F21V 23/04; F21S 9/02; B66F 19/00

(52) U.S. Cl. CPC B62D 53/068; B66F 19/00; F21S 9/02; F21V 23/04

(57) ABSTRACT

A portable apparatus for remotely actuating a button for tandem axle adjustment on a semitrailer is disclosed. The portable apparatus comprises a shaft configured to have a first end and a second end to define an elongated tube-like structure, wherein the first end comprises a V-shaped attachment to actuate the button to discharge the locking mechanism of the sliding tandem when a user maneuvers the shaft into a frame of the semitrailer by a gripping member attached to the second end of the shaft. A mounting member is removably attached to the shaft at a predefined position to support an illuminating device to light up the button for tandem axle adjustment in a low visibility condition.

### BACKGROUND OF THE INVENTION

### A. Technical Field

The present invention is generally relates to trailer tandem axles. More particularly, the invention disclosed herein is related to a portable apparatus for remotely actuating a button for tandem axle adjustment on a semitrailer.

### B. Description of Related Art

Tandem axles in general refer to two closely spaced axles used in vehicles such as heavy trucks or trailers. Tandem axles are preferred over single axles in trucks and trailers for their ability to handle more weight. Trailers with two axles are referred to as tandem axle trailers. The federal weight limit for tandem axle trailers on the highway is about 34,000 pounds. The frame plate of the tandem trailer is machined with a series of holes into which the locking pins fit. These pins are retracted or extended by air pressure and is controlled by the locking lever or button. This lever or button is either located on the trailer frame under the trailer body at the left front of the sliding tandem or mounted within the framework of the tandem with access through a ‘D’ shaped cutout near the left front. Sliding the tandems provide the driver with an option to shift some of the weight of trailer load to, or from, the tractor drive and steer wheels.

Additionally, the tandem axle, when not in use, could be raised off the ground enabling the trailer to revert to a single axle. Typically, when the load on the tractor and trailer wheels needs to be adjusted, the driver must kneel or crawl partway under the trailer to release the slider pins so the trailer wheels could be moved. If the area is dusty or they need to be moved in inclement weather, the driver could really get dirt, requiring cleanup before beginning the drive. This is highly disadvantageous especially if the driver needs to adjust the trailer axle multiple times during a trip.

Furthermore, trailer vehicles are driven for hundreds of miles through the night and day time during a trip. If it is at night and in a dark area, the driver must carry or wear a headlamp to illuminate the release lever or button for access and this could be cumbersome and creates lot of inconvenience. Crawling under the trailer could also subject the driver to accidental injury if the brakes are not set properly or air pressure is lost.

Few attempts have been made to resolve this issue by providing an axle release tool for trucks. Prior art reference U.S. Pat. No. 6,354,642 B1 discloses a puller and locator for trailer tandem axle units wherein a tension spring extending from an external attachment point and reflectors are provided. However, the tool design is cumbersome and the user must apply a high tensile force to release the handle. The tool could not be used in low visibility conditions.

Another prior art reference U.S. Pat. No. 6,375,162 B1 discloses a trailer tandem release leverage bar wherein a flexible tension member the flexible tension member having a pin handle engagement end and a rigid cam connection end is provided. However, the resilient foot requires an external force to an extent to release the pin. Again, this tool could not be used in low visibility conditions when the driver needs to adjust the tandem axle.

Hence, there is a long felt but unresolved need for an apparatus, which aids a user to release or adjust the tandem axles of a trailer without crawling or kneeling under the frame of the trailer. Furthermore, there is a need for an apparatus, which provides illumination to aid the user to view the release lever in dark or low visibility conditions.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The invention disclosed herein addresses the above-mentioned need for an apparatus, which aids a user to release or adjust the tandem axles of a trailer without crawling or kneeling under the frame of the trailer. Furthermore, the invention addresses the need for a tandem axle release apparatus, which provides illumination to aid the user to view the release lever in dark or low visibility conditions. The portable apparatus for tandem axle adjustment resolves most of these problems by providing a shaft configured to have a first end and a second end to define an elongated tube-like structure, wherein the first end comprises a V-shaped attachment to actuate the button to discharge the locking mechanism of the sliding tandem when a user maneuvers the shaft into a frame of the semitrailer by a gripping member attached to the second end of the shaft.

The portable apparatus for tandem axle adjustment comprises a shaft, a gripping member, a V-shaped attachment, a mounting member and an illuminating device. In low light or dark areas, the illuminating device supported on the mounting member is configured to illuminate the V-shaped attachment so that the user could easily locate the button to release the locking mechanism of the sliding tandem without crawling under the trailer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a perspective view of a portable apparatus for tandem axle adjustment.

FIG. 2 exemplarily illustrates a front view of a V-shaped attachment of the portable apparatus for tandem axle adjustment.

FIG. 3 exemplarily illustrates a front elevation view of the portable apparatus for tandem axle adjustment.

FIG. 4 exemplarily illustrates a top plan view of the portable apparatus for tandem axle adjustment.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

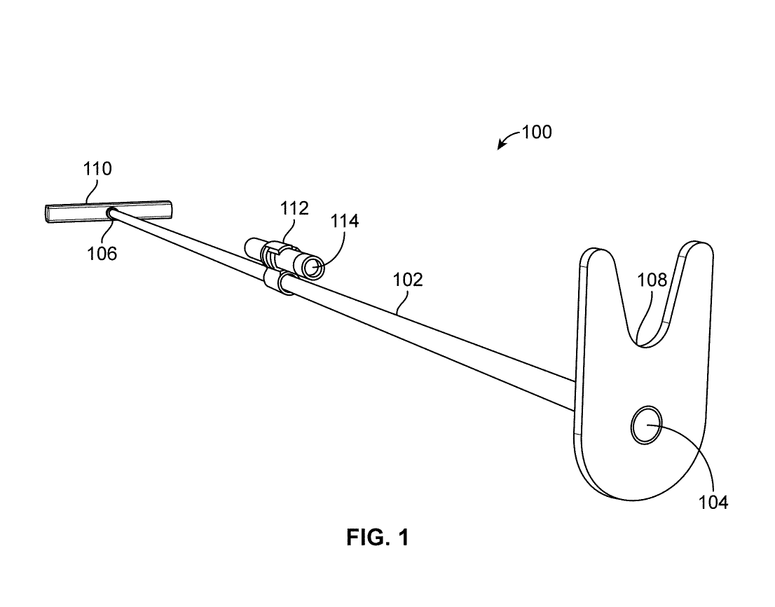

The disclosed invention relates to a portable apparatus for remotely actuating a button for tandem axle adjustment on a semitrailer. FIG. 1 exemplarily illustrates a perspective view of a portable apparatus 100 for tandem axle adjustment. The portable apparatus 100 for remotely actuating a button for tandem axle adjustment on a semitrailer aids a user to release or adjust the tandem axles of a trailer without crawling or kneeling under the frame of the trailer. The portable apparatus 100 for tandem axle adjustment comprises a shaft 102 configured to have a first end 104 and a second end 106 to define an elongated tube-like structure, wherein the first end 104 comprises a V-shaped attachment 108 to actuate the button to discharge the locking mechanism of the sliding tandem when a user maneuvers the shaft 102 into a frame of the semitrailer by a gripping member 110 attached to the second end 106 of the shaft 102. The portable apparatus 100 for tandem axle adjustment also comprises a mounting member 112 removably attached to the shaft 102 at a predefined position to support an illuminating device 114 to provide light for the user to easily locate the button to release the locking mechanism of the sliding tandem without crawling under the trailer in low light or dark areas. The shaft 102 is made from a steel material.

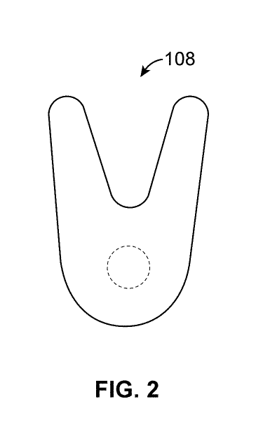

FIG. 2 exemplarily illustrates a front view of a V-shaped attachment 108 of the portable apparatus 100 for tandem axle adjustment. The V-shaped attachment 108 is made from a steel material which is perfectly sized and configured to access and actuate the button easily with very minimal force to allow the user to adjust the tandem axle by standing outside the edge of the trailer. In low light or low visibility conditions, the V-shaped attachment 108 is illuminated by the illuminating device 114 fixed on the mounting member 112 so that the user could get easy access of the V-shaped attachment 108 without crawling under the trailer. The V-shaped attachment 108 is plug-welded and fixedly attached to the first end 104 of the shaft 102 via a plurality of threads configured on the shaft 102 of the portable apparatus 100.

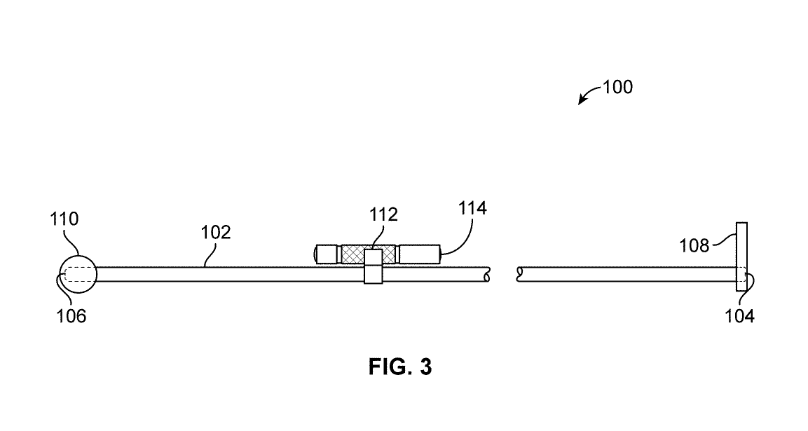

In an embodiment, the gripping member 110 is a handle removably attached to the second end 106 of the shaft 102 via a plurality of threads configured on the shaft 102, as shown in FIG. 3. The gripping member 110 is configured to assist the user in holding the portable apparatus 100 to maneuvers the shaft 102 into the frame of the semitrailer to adjust the tandem axle without crawling under the trailer. The gripping member 110 comprises a textured surface, which improves the grip during use, especially in inclement weather. The gripping member 110 is removably attached to the second end 106 of the shaft 102 via a plurality of threads configured on the shaft 102. The gripping member 110 is coated with a plurality of fluorescent colors to increase the visibility when the user maneuvers the shaft 102 into the frame of the semitrailer in low visibility conditions. The gripping member 110 is made from an extruded polypropylene material. In additional embodiments, the generally V-shaped attachment 108 and the gripping member 110 are fixedly attached to opposing ends of the shaft 102 after the threads configured on the shaft 102 are coated with positive locking chemical locking adhesive for reinforcement.

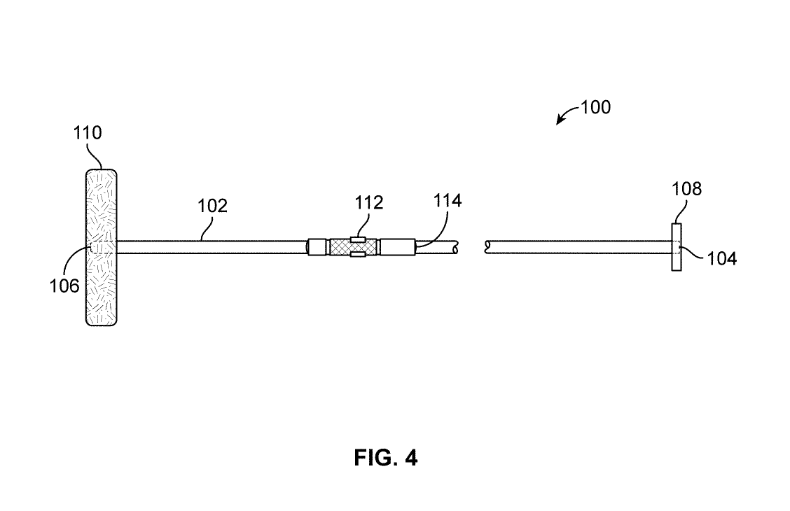

In another embodiment, the mounting member 112 is configured to be slidably movable on the shaft 102 to assist the user in viewing the button for tandem axle adjustment in a low visibility condition, as shown in FIG. 4. Preferably, the mounting member 112 could be placed in the middle of the shaft 102. However, based on the requirements, the user could fix the position of mounting member 112 on the shaft 102 to selectively illuminate the frame of the semitrailer for tandem axle adjustment. The mounting member 112 is made from a plastic material. Preferably, flexible polymers could be used for improved flexibility and strength. In a different embodiment, a sealed rubber button (not shown) could be provided on the back side of the illuminating device 114 to selectively activate the light source in low visibility conditions. A single AA battery is used to power the light source. The illuminating device 114 is any light source selected from at least one of a flashlight, a penlight, a torch and an LED light. The mounting member 112 secures the light source 114 firmly when the light source 114 is mounted on the portable apparatus 100. The compliant plastic mounting member 112 could be removed from the portable apparatus 100 if not required for use.

In an embodiment, the manufacturing of the components of the portable apparatus 100 for tandem axle adjustment, as shown in FIG. 4. The gripping member 110 is made in dimensions of about 1.0-inch diameter from a polypropylene extruded rod. The computer numerically controlled (CNC) lathe automatically textures the surface and then cuts off the 5.0-inch long piece. The ends of the gripping member 110 are rounded in this operation as well, keeping the cost down. After the CNC lathe work, the gripping member 110 is robotically transferred, drilled, and tapped to accept the shaft 102. In an embodiment, the shaft 102 is cut to a desired length from a 0.5-inch diameter extruded steel rod. The shaft 102 is cut, for example, to a length of about 36-inches and is threaded with ½-20 fine threads on the CNC lathe, which also cuts the shaft 102 to the desired length. The shaft 102 is detachably attached to the gripping member 110 via the fine threads configured on the shaft 102.

In an embodiment, the portable apparatus 100 for tandem axle adjustment is suspended on the cabin of the semitrailer by a plurality of mounting clamps and stainless steel fasteners. Alternately, the portable apparatus 100 is stored in the cabin or a toolbox of the vehicle. The 0.25-inch thick steel generally V-shaped attachment 108 is drilled and plug welded to the end of the shaft 102 to insure durability during use. The generally V-shaped attachment 108 is cut to shape on a computer numerically controlled (CNC) water jet machining center from 0.25-inch thick cold rolled steel. Preferably, the shaft 102 and the V-shaped attachment 108 components are powder painted and thermally cured by a corrosion and scratch resistant material. Acrylic polymer coatings could be used for this purpose.

In various embodiments, the method of using the portable apparatus 100 for tandem axle adjustment, as shown in FIG. 1. The user could locate the button on the frame of the trailer to adjust the tandem axle, V-shaped attachment 108, which is placed in such a way to clasp the button and gently pulling it outwards. The air gets released through valve and locking pins is disengaged so that the user could adjust the position of tandem axle. Once the adjustment is done, the button is pushed back to re-engage the locking pins into the trailer frame securely.

The portable apparatus 100 for tandem axle adjustment allows the user to easily and safely actuate the release lever or button needed to discharge the locking mechanism of the sliding tandem without crawling under the frame of the semitrailer. This prevents the user from soiling his clothes while carrying out the task, even in inclement weather. Moreover, the portable apparatus 100 prevents accidents from happening if the user forgets to engage the lock brakes of both the trailer and the tractor. The gripping member 110 allows the user to easily maneuver the portable apparatus 100 to reach under the trailer and pull out the locking lever or release it quickly and easily with very less effort. The illuminating device 114 in the portable apparatus 100 allows the user to clearly view the button to actuate the release in low visibility conditions and thereby eliminating the need for a separate headlight or other lamps. The portable apparatus 100 is durable and light-weight. The portable apparatus 100 is painted with various vibrant colors to enhance the identification of the apparatus 100.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

1. A portable apparatus for remotely actuating a button for tandem axle adjustment on a semitrailer, the portable apparatus comprising:
a shaft configured to have a first end and a second end to define an elongated tube-like structure, wherein the first end comprises a V-shaped attachment to actuate the button to discharge the locking mechanism of the sliding tandem when a user maneuvers the shaft into a frame of the semitrailer by a gripping member attached to the second end of the shaft, and
a mounting member is removably attached to the shaft at a predefined position, wherein the mounting member is configured to support an illuminating device.

2. The portable apparatus of claim 1, wherein the V-shaped attachment in the first end of the shaft is configured to actuate the button thereby allowing the user to adjust the tandem axle without crawling under the frame of the semitrailer.

3. The portable apparatus of claim 1, wherein the V-shaped attachment is plug-welded and fixedly attached to the first end of the shaft via a plurality of threads configured on the shaft.

4. The portable apparatus of claim 1, wherein the gripping member is removably attached to the second end of the shaft via a plurality of threads configured on the shaft.

5. The portable apparatus of claim 1, wherein the threads on the shaft are coated with an adhesive material.

6. The portable apparatus of claim 1, wherein the mounting member is configured to slidably movable on the shaft to assist the user in viewing the button for tandem axle adjustment in a low visibility condition.

7. The portable apparatus of claim 1, wherein the illuminating device is selected from at least one of a flashlight, a penlight, a torch and an LED light.

8. The portable apparatus of claim 1, wherein a sealed rubber button is provided on the illuminating device to selectively activate the light source.

9. The portable apparatus of claim 1, wherein the gripping member is made from an extruded polypropylene material.

10. The portable apparatus of claim 1, wherein the gripping member is coated with a plurality of fluorescent colors to increase the visibility when the user maneuvers the shaft into the frame of the semitrailer.

11. The portable apparatus of claim 1, wherein the shaft is made from a steel material.

12. The portable apparatus of claim 1, wherein the mounting member is made from a plastic material.

13. The portable apparatus of claim 1, is suspended from the cabin of the semitrailer by a plurality of mounting clamps and stainless steel fasteners.
